(19) United States
(12) Patent Application Publication
(10) Pub. No.: US 2004/0216556 A1
(43) Pub. Date: Nov. 4, 2004

(54) Composite differential carrier having cage-type differential carrier frame member

(76) Inventors: Todd A. Smith, Perrysburg, OH (US); Michael J. Catalano, Toledo, OH (US); Edward Eugene Stuart, Payne, OH (US); Ken E. Cooper, Toledo, OH (US)

Correspondence Address: Liniak, Berenato & White, Ste. 240, 6550 Rock Spring Drive, Bethesda, MD, 20817, US

(21) Appl. No.: 10/425,707

(22) Filed: Apr. 30, 2003

(51) Int. Cl. F16H 57/02

(52) U.S. Cl. 74/607

(57) ABSTRACT

A differential carrier, adapted to rotatably support a differential assembly and a final drive assembly, includes an integrally formed cage-type differential carrier frame member comprising a pair of axially spaced pinion support members for rotatably supporting a pinion drive shaft, a pair of laterally spaced opposite differential support members for rotatably supporting a differential case, at least one first arm member interconnecting the pinion support members, and at least two second arm members each interconnecting at least one of the pinion support members with one of the differential support members to thereby define a cage-type space frame of the differential carrier. The differential carrier frame member further comprises a continuous flange member integrally secured to the differential support members and defining a rear access opening in the differential carrier, and a mounting member for mounting the differential carrier to a vehicle sprung mass.

### BACKGROUND OF THE INVENTION

1. Field of the Invention

The present invention relates to differential carriers of axle assemblies for motor vehicles in general, and more particularly to a composite differential carrier for rotatably supporting a differential case and a pinion drive shaft of a final drive assembly including a cage-type differential carrier frame member.

2. Description of the Prior Art

Referring first to FIG. 1, a typical axle assembly for a motor vehicle includes a differential carrier 12, which contains a differential mechanism, a pinion drive shaft of a final drive assembly and a reservoir of hydraulic lubricant, a pair of opposite axle tubes 14 and 16 extending outboard from ends of the differential carrier 12, and axle shafts (not shown) drivingly supported within the axle tubes 14 and 16. A cover plate 20 is connected by bolts 22 to the rear face 23 of the differential carrier 12 hydraulically seals the differential carrier 12 against the leakage of lubricant.

The differential carrier 12 also includes laterally directed tubular extensions 24 and 26, which receive therein the ends of the axle tubes 14 and 16, respectively. Located within the differential carrier 12 is a differential case 28, on which bevel pinion gears 30 are supported for rotation on a differential pinion shaft 32. Side bevel gears 34 and 36 are in continuous meshing engagement with pinion gears 30 and are drivingly connected to the left and right axle shafts located respectively within tubes 14 and 16. The differential mechanism, located within the differential case 28, includes a ring gear 42, in continuous meshing engagement with the pinion drive shaft 38.

Located within the differential carrier 12 is a pinion drive shaft 38 rotatably supported by front and rear drive pinion bearings (only the rear drive pinion bearing 39 is shown) supported on an inner surface of a front portion 15 of the differential carrier 12. A driveshaft (not shown) drivingly connected to an output shaft of a transmission (not shown), is connected through splines 40 to the pinion drive shaft 38.

The differential carrier is typically manufactured by casting from heavy and expensive cast iron or light weight aluminum alloys. However, the cast aluminum and cast iron differential carriers have their disadvantages. The cast iron differential carriers are relatively heavy and expensive. The cast aluminum differential carriers are relatively expensive, weak and temperature sensitive. Moreover, the cast aluminum differential carriers cause problems during assembly of the differential case and the pinion drive shaft while pressing bearing cups into respective bores in the carrier due to inherit weakness of the aluminum alloy material of the carrier.

### SUMMARY OF THE INVENTION

The present invention provides a novel composite differential carrier for rotatably supporting a differential case and a pinion drive shaft of a final drive assembly including a cage-type differential carrier frame member.

The differential carrier of the present invention includes a cage-type differential carrier frame member comprising a pair of axially spaced pinion support members supporting a pinion drive shaft of the final drive assembly for rotation about an input axis, a pair of laterally spaced opposite differential support members supporting a differential case of the differential assembly for rotation about an output axis, at least one first arm member interconnecting the pinion support members, and at least two second arm members each interconnecting at least one of the pinion support members with the differential hub members to thereby define a cage-type space frame of the differential carrier.

Preferably, the pinion support members are in the form of substantially cylindrical rings. Each of the pinion support members is provided with substantially cylindrical pinion bores therethough. The cylindrical pinion bores are substantially coaxial to the input axis. The pinion bores are adapted to receive anti-friction bearings, such as conventional tapered roller bearings, provided for rotatably supporting the pinion drive shaft within the differential carrier frame member.

Similarly preferably, the differential support members are in the form of substantially annular rings. The differential support members are generally aligned and spaced in the direction of the output axis. Each of the differential support members is provided with a respective, substantially cylindrical hub bore therethrough. The hub bores are aligned substantially coaxial with the output axis. The hub bores are adapted to receive anti-friction bearings, such as conventional tapered roller bearings, provided for supporting the differential case within the differential carrier frame member for rotation about the output axis.

The cage-type differential carrier member in accordance with the preferred embodiment of the present invention further comprises a continuous flange member integrally secured to the differential support members and defining a rear access opening in the differential carrier. The flange member is provided for securing a rear cover plate of the differential carrier thereto.

The cage-type differential carrier frame member also includes a mounting member for mounting the differential carrier to a vehicle sprung mass. Preferably, the differential carrier is elastically mounted to the vehicle sprung mass through an appropriate elastic member, such as an elastic bushing provided in a hole formed in the mounting member.

The cage-type differential carrier frame member of the differential carrier of the present invention is, preferably, formed as an integral cage-type frame component. More preferably, the cage-type differential carrier frame member is manufactured by casting from iron of appropriate grade and strength as a unitary, homogeneously formed single-piece metal component. However, any other appropriate methods of manufacturing the cage-type differential carrier frame member, such as welding, forming, molding, etc., are within the scope of the present invention.

Openings between the arm members of the cage-type space frame member are filled with lightweight, relatively inexpensive aluminum alloy or lightweight magnesium alloy by metal casting or dipping, thus forming the enclosed, hollow differential carrier of the present invention provided with a cavity within the differential carrier defining a lubricant reservoir adapted to contain a predetermined amount of a lubricant therein. The rear access opening in the differential carrier defined by the flange member is not filled with the cover material. Conversely, the cage-type carrier frame member may be wrapped with one or more layers of the lightweight fiber reinforced composite matrix material (or any other appropriate material, such as thin sheet of aluminum or magnesium foil) so as to form the enclosed, hollow differential carrier of the present invention.

Therefore, the device in accordance with the present invention represents a novel arrangement of the differential carrier including the cage-type carrier frame member rotatably supporting the differential assembly and the final drive assembly. The composite differential carrier in accordance with the present invention allows to use less amount of relatively expensive, high quality, higher strength material only in high stress areas supporting pinion shaft and differential case bearings, and relatively cheap, weaker material in low stress areas. Thus, the composite differential carrier of the present invention is substantially lighter and less costly in production than the typical differential carriers currently manufactured.

### BRIEF DESCRIPTION OF THE DRAWINGS

Other objects and advantages of the invention will become apparent from a study of the following specification when viewed in light of the accompanying drawings, wherein:

FIG. 1 is an exploded perspective view of a typical drive axle assembly of the prior art;

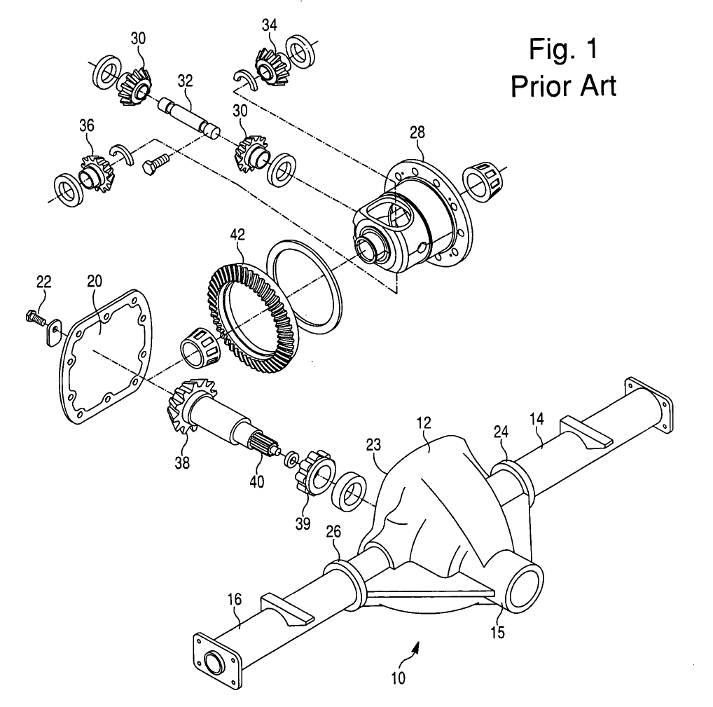

FIG. 2 is a perspective front view of a differential carrier in accordance with the preferred embodiment of the present invention;

FIG. 3 is a perspective right side view of the differential carrier in accordance with the preferred embodiment of the present invention;

FIG. 4 is a perspective left side view of the differential carrier in accordance with the preferred embodiment of the present invention;

FIG. 5 is a perspective top view of the differential carrier in accordance with the preferred embodiment of the present invention;

FIG. 6 is a perspective rear view of the differential carrier in accordance with the preferred embodiment of the present invention;

FIG. 7 is a perspective side view of a cage-type differential carrier frame member in accordance with the preferred embodiment of the present invention;

FIG. 8 is a perspective front view of the cage-type differential carrier frame member in accordance with the preferred embodiment of the present invention;

FIG. 9 is a perspective top view of the cage-type differential carrier frame member in accordance with the preferred embodiment of the present invention;

FIG. 10 is a perspective rear view of the cage-type differential carrier frame member in accordance with the preferred embodiment of the present invention.

### DETAILED DESCRIPTION OF PREFERRED EMBODIMENTS

The preferred embodiments of the present invention will now be described with the reference to accompanying drawings.

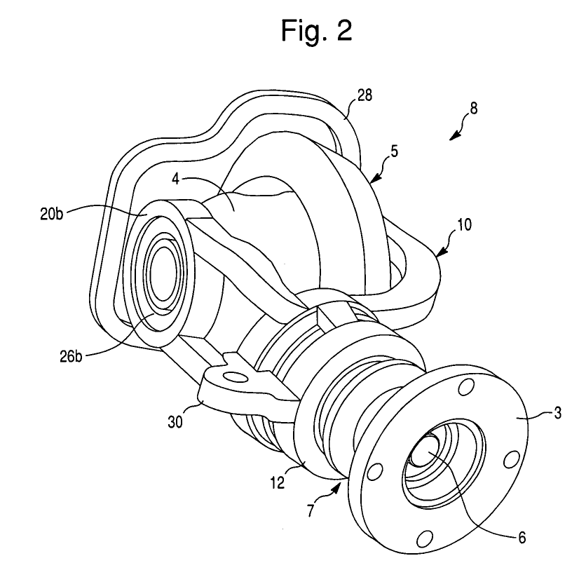

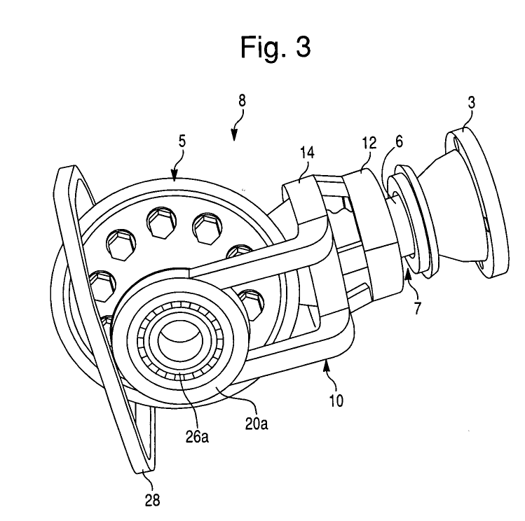

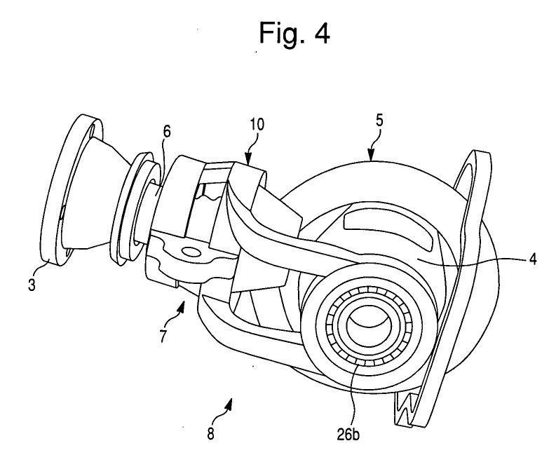

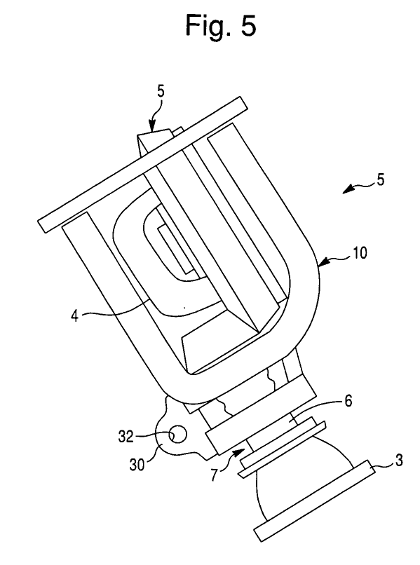

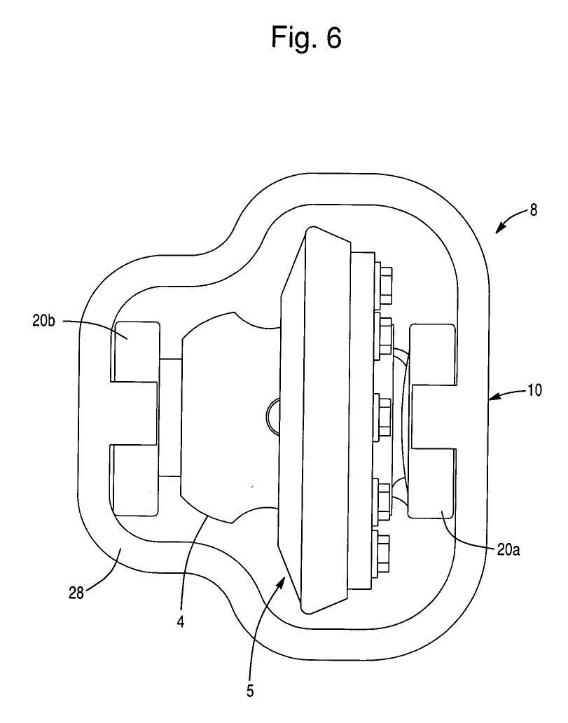

As illustrated in FIGS. 2-6, the present invention is directed to a differential carrier 8 of a drive axle of a motor vehicle (not shown). The differential carrier 8 is adapted to rotatably support a differential case 4 of a differential assembly 5 and a pinion drive shaft 6 of a final drive assembly 7, as shown in FIGS. 2-6. As illustrated, the pinion drive shaft 6 is rotatable about an input axis A, while the differential case 4 is rotatable about an output axis B. As further illustrated in FIGS. 2-5, a drive flange 3 is attached to an outward end of the pinion drive shaft 6 for drivingly coupling the final drive assembly 7 to a drive shaft (propeller shaft) of the motor vehicle.

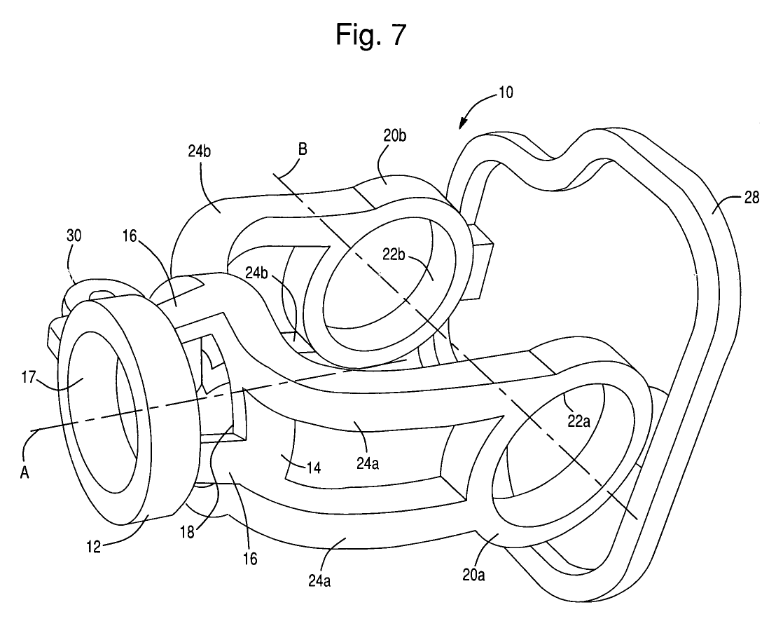

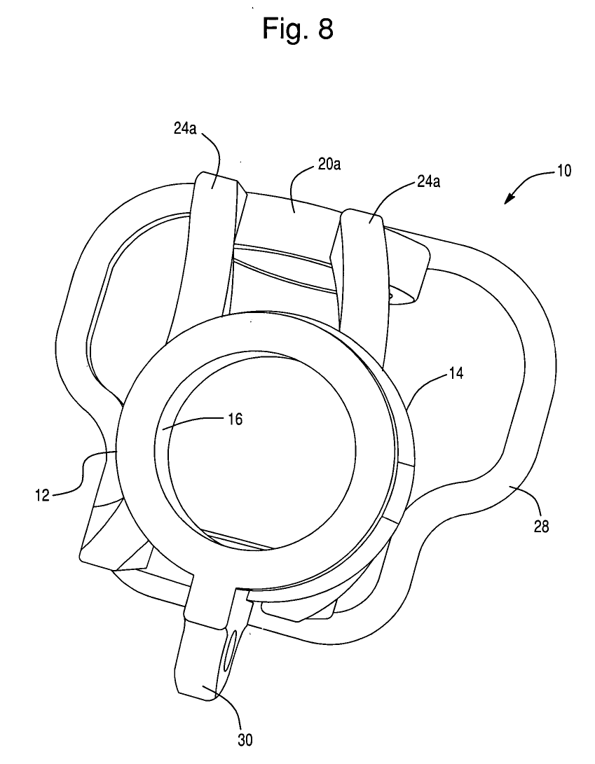

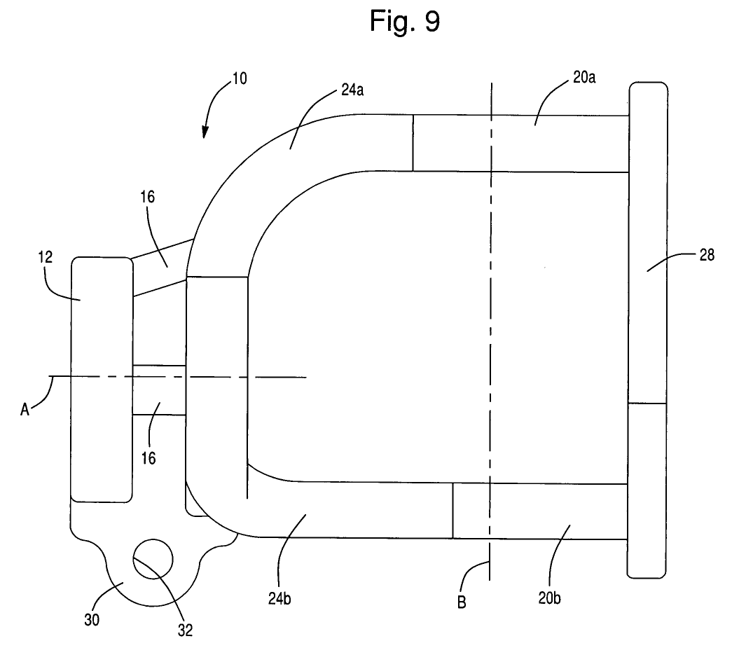

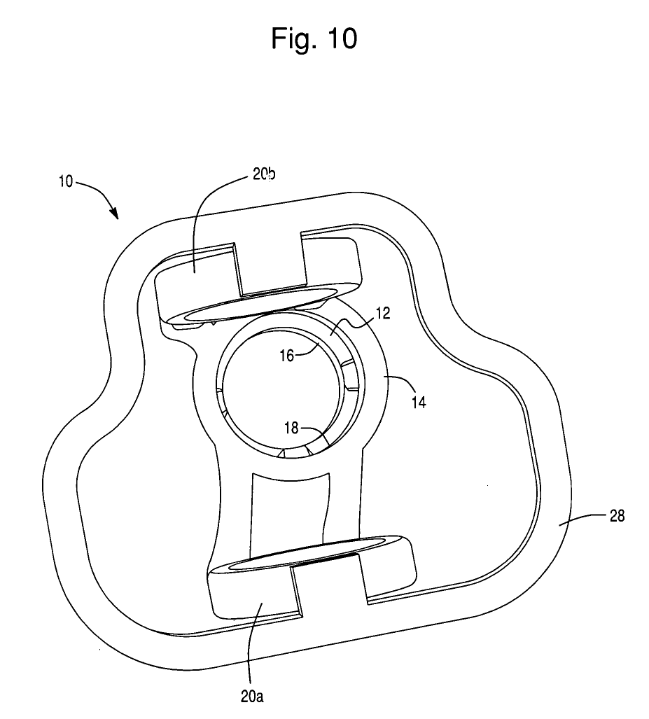

The differential carrier 8 of the present invention includes a cage-type differential carrier frame member, generally indicated by the reference numeral 10 and illustrated in details in FIGS. 7-10. The carrier frame member 10 comprises a pair of axially spaced pinion support members 12 and 14 for rotatably supporting the pinion drive shaft 6, a pair of laterally spaced opposite differential support members 20a and 20b for rotatably supporting the differential case 4, at least one first arm member 16 interconnecting the pinion support members 12 and 14, and at least two second arm members 24a and 24b each interconnecting at least one of the pinion support members 12 and 14 with the differential hub members 20a and 20b to thereby define a cage-type space frame of the differential carrier 8.

As depicted in FIGS. 7-10, the support member 12 may be described as an outer pinion support member, while the support member 14 may be described as an inner pinion support member. Preferably, the pinion support members 12 and 14 are in the form of substantially cylindrical rings, as illustrated in FIGS. 7-10. Each of the pinion support members 12 and 14 is provided with substantially cylindrical pinion bores 17 and 18, respectively, therethough. The cylindrical pinion bores 17 and 18 are substantially aligned along the input axis A. Preferably, the input axis A coincides with an axis of symmetry of the pinion drive shaft 6. The pinion bores 17 and 18 are adapted to receive anti-friction bearings (not shown), such as conventional tapered roller bearings, provided for rotatably supporting the pinion drive shaft 6 within the differential carrier frame member 10.

Preferably, the differential support members 20a and 20b are in the form of substantially annular rings, as illustrated in FIGS. 7-10. The differential support members 20a and 20b are generally aligned and spaced in the direction of the output axis B. Each of the differential support members 20a and 20b is provided with a respective, substantially cylindrical hub bore 22a and 22b respectively, therethrough. The hub bores 22a and 22b are aligned substantially along the output axis B. The hub bores 22a and 22b are adapted to receive anti-friction bearings 26a and 26b respectively, such as conventional tapered roller bearings, provided for supporting the differential case 4 within the differential carrier frame member 10 for rotation about the output axis B, as illustrated in FIGS. 2-4.

As disclosed above, the cage-type differential carrier frame member 10 further includes at least one generally identical first arm member 16 each interconnecting the outer and inner pinion support members 12 and 14. In accordance with the preferred embodiment of the present invention, as illustrated in FIGS. 7-10, the differential carrier frame member 10 includes three substantially identical first arm members 16 circumferentially spaced about the input axis A. It will be appreciated by those skilled in the art that any appropriate number of the first arm members 16 may be employed. Moreover, the first arm members 16 may not necessarily be identical.

The cage-type differential carrier frame member 10 also includes at least two generally identical second arm members 24a and 24b interconnecting the differential support members 20a and 20b with the inner pinion support member 14. In accordance with the preferred embodiment of the present invention, as illustrated in FIGS. 7-10, the differential carrier frame member 10 includes two pairs of substantially identical second arm members 24a and 24b, wherein one pair of second arm members 24a interconnects the inner pinion support member 14 with the differential support member 20a, while another pair of second arm members 24b interconnects the inner pinion support member 14 with the differential support member 20b. It will be appreciated by those skilled in the art that any appropriate number of the second arm members 24a and 24b may be employed. Moreover, the second arm members 24a and 24b may not necessarily be identical.

Thus, integrally formed the outer and inner pinion support members 12 and 14, the differential support members 20a and 20b, the first arm members 16 and second arm members 24a and 24b define the cage-type differential carrier frame member 10.

In accordance with the preferred embodiment of the present invention, the cage-type differential carrier member further comprises a continuous flange member 28 integrally secured to the differential support members 20a and 20b and defining a rear access opening in the differential carrier 8. The flange member 28 is provided for securing a rear cover plate (not shown) of the differential carrier 8 thereto.

In accordance with the preferred embodiment of the present invention, the cage-type differential carrier frame member 10 also includes a mounting member 30 at a front portion thereof for mounting the differential carrier 8 to a vehicle sprung mass (not shown). Preferably, the mounting member 30 extends between the outer and inner pinion support members 12 and 14. Also preferably, the differential carrier 8 is elastically mounted to the vehicle sprung mass through an appropriate elastic member, such as an elastic bushing (not shown) provided in a hole 32 formed in the mounting member 30.

Preferably, the cage-type differential carrier frame member 10 of the differential carrier 8 of the present invention is formed as an integral cage-type frame component. More preferably, the cage-type differential carrier frame member 10 is manufactured by casting from iron of appropriate grade and strength as a unitary, homogeneously formed single-piece component. Alternatively, the cage-type differential carrier frame member 10 may be manufactured by welding together the pinion support members 12 and 14, the differential support members 20a and 20b, the first arm members 16 and second arm members 24a and 24b, the mounting member 30 and the flange member 28, or otherwise integrally secured together (such as adhesively bonded or connected by threaded fasteners) those elements of the carrier frame member 10. It will be appreciated by those skilled in the art that any other appropriate methods of manufacturing the cage-type differential carrier frame member, such as forming, molding, etc., are within the scope of the present invention. Also, other metal materials, such as steel, titanium, magnesium, aluminum alloys, or strong non-metal composite materials, such as fiber reinforced composite resin matrix material, may be employed for manufacturing of the carrier frame member of the present invention, where more strength is needed.

After the cage-type space frame member 10 is formed, openings between the arm members 16, 24a and 24b are filled with lightweight, relatively inexpensive aluminum alloy by metal casting or dipping, thus forming the enclosed, hollow differential carrier 8 of the present invention provided with a cavity within the differential carrier 8 defining a lubricant reservoir adapted to contain a predetermined amount of a lubricant therein. Alternatively, openings in the cage-type carrier frame member 10 may be filled with appropriate plastic material, or any other suitable material well known in the art. It will be appreciated by those skilled in the art that the rear access opening in the differential carrier 8 defined by the flange member 28 is not filled with the cover material.

Conversely, the cage-type carrier frame member 10 may be wrapped with one or more layers of the lightweight fiber reinforced composite matrix material (or any other appropriate material, such as thin sheet of aluminum or magnesium foil) so as to form the enclosed, hollow differential carrier 8 of the present invention. Again, the rear access opening in the differential carrier 8 defined by the flange member 28 is left open.

Therefore, the apparatus in accordance with the present invention represents a novel arrangement of the differential carrier including the cage-type carrier frame member rotatably supporting the differential assembly and the final drive assembly. The composite differential carrier in accordance with the present invention provides a number of advantages over the currently employed arrangements. More specifically, it allows to use less amount of relatively expensive, high quality, higher strength material only in high stress areas supporting pinion shaft and differential case bearings, and relatively inexpensive, weaker material in low stress areas. Thus, the composite differential carrier of the present invention is substantially lighter and less temperature sensitive, and less costly in production than the typical differential carriers currently manufactured.

The foregoing description of the preferred embodiments of the present invention has been presented for the purpose of illustration in accordance with the provisions of the Patent Statutes. It is not intended to be exhaustive or to limit the invention to the precise forms disclosed. Obvious modifications or variations are possible in light of the above teachings. The embodiments disclosed hereinabove were chosen in order to best illustrate the principles of the present invention and its practical application to thereby enable those of ordinary skill in the art to best utilize the invention in various embodiments and with various modifications as are suited to the particular use contemplated, as long as the principles described herein are followed. Thus, changes can be made in the above-described invention without departing from the intent and scope thereof. It is also intended that the scope of the present invention be defined by the claims appended thereto.

1. A differential carrier for rotatably supporting a differential case of a differential assembly and a pinion drive shaft of a final drive assembly, said differential case is rotatable about an output axis, said pinion drive shaft is rotatable about an input axis, said carrier comprising a cage-type differential carrier frame member including:
a pair of axially spaced pinion support members for rotatably supporting said pinion drive shaft, said pinion support members spaced substantially in the direction of said input axis;
a pair of laterally spaced differential support members for rotatably supporting said differential case, said differential support members spaced substantially along said output axis;
at least two first arm members interconnecting said pinion support members; and
at least two second arm members each interconnecting at least one of said pinion support members with one of said pair of differential support members to thereby define a cage-type space frame of said differential carrier.

2. The differential carrier as defined in claim 1, wherein said input axis is substantially perpendicular to said output axis.

3. The differential carrier as defined in claim 1, wherein each of said pinion support members having a substantially cylindrical pinion support bore therethrough substantially coaxial with said input axis.

4. The differential carrier as defined in claim 3, wherein said pinion support bore in each of said pinion support members is provided for receiving a pinion bearing for rotatably supporting said pinion drive shaft in said differential carrier.

5. The differential carrier as defined in claim 1, wherein each of said differential support members having a substantially cylindrical hub bore therethrough substantially coaxial with said output axis.

6. The differential carrier as defined in claim 5, wherein said hub bore in each of said differential support members is provided for receiving a differential bearing for rotatably supporting said differential case in said differential carrier.

7. The differential carrier as defined in claim 1, wherein said pinion support members and said differential support members of said differential carrier frame member are formed integrally with said at least two first arm members and said at least two second arm members.

8. The differential carrier as defined in claim 7, wherein said differential carrier frame member of said differential carrier is formed as a homogeneous single-piece part.

9. The cage-type differential carrier as defined in claim 8, wherein said cage-type space frame member is manufactured by casting.

10. The differential carrier as defined in claim 1, wherein said differential carrier frame member comprising three first arm members spaced about said input axis and interconnecting said pinion support members.

11. The differential carrier as defined in claim 1, wherein said differential carrier frame member comprising two opposite pairs of said second arm members, each pair of said second arm members interconnecting at least one of said pinion support members with one of said opposite differential support members.

12. The differential carrier as defined in claim 1, further comprising a cover material filling in gaps in said differential carrier frame member for forming a cavity within said differential carrier defining a lubricant reservoir adapted to contain a predetermined amount of a lubricant.

13. The differential carrier as defined in claim 1, further comprising at least one layer of cover material wrapping said differential carrier frame member for forming a cavity within said differential carrier defining a lubricant reservoir adapted to contain a predetermined amount of a lubricant.

14. The differential carrier as defined in claim 1, further comprising a flange member defining a rear access opening in said differential carrier and provided for securing thereto a rear cover plate.

15. The differential carrier as defined in claim 14, wherein said flange member is attached to said differential support members.

16. The differential carrier as defined in claim 14, wherein said flange member is formed integrally with said cage-type space frame member.

17. The differential carrier as defined in claim 16, wherein said flange member is formed integrally with said cage-type space frame member as a homogeneous single-piece component.

18. The differential carrier as defined in claim 17, wherein said cage-type space frame member is manufactured by casting.

19. The differential carrier as defined in claim 14, further comprising a cover material filling in gaps in said cage-type space frame member for forming a cavity within said cage-type differential carrier defining a lubricant reservoir adapted to contain a predetermined amount of a lubricant, wherein said rear access opening is not filled with said cover material.

20. The differential carrier as defined in claim 14, further comprising at least one layer of cover material wrapping said differential carrier frame member for forming a cavity within said differential carrier defining a lubricant reservoir adapted to contain a predetermined amount of a lubricant, wherein said rear access opening is not filled with said cover material.

21. The differential carrier as defined in claim 1, further comprising a mounting member attached to said differential carrier frame member for mounting said differential carrier to a vehicle sprung mass.

22. The differential carrier as defined in claim 21, wherein said mounting member is formed integrally with said differential carrier frame member.

23. A differential carrier for rotatably supporting a differential case of a differential assembly and a pinion drive shaft of a final drive assembly, said differential case rotatable about an output axis, said pinion drive shaft rotatable about an input axis, said carrier comprising a cage-type differential carrier frame member including:
at least one pinion support member for rotatably supporting said pinion drive shaft;
a pair of laterally spaced differential support members for rotatably supporting said differential case, said differential support members spaced substantially along said output axis;
at least two second arm members each interconnecting said at least one pinion support member with one of said pair of differential support members to thereby define a cage-type space frame of said differential carrier; and
a flange member defining a rear access opening in said differential carrier and provided for securing thereto a rear cover plate.

24. The differential carrier as defined in claim 23, wherein said flange member is attached to said differential support members.

25. The differential carrier as defined in claim 23, wherein said flange member is formed integrally with said differential carrier frame member.

26. The differential carrier as defined in claim 25 wherein said flange member is formed integrally with said differential carrier frame member as a unitary single-piece component.

27. A differential carrier for rotatably supporting a differential case of a differential assembly and a pinion drive shaft of a final drive assembly, said differential case rotatable about an output axis, said pinion drive shaft rotatable about an input axis, said carrier comprising a cage-type differential carrier frame member including:
at least one pinion support member for rotatably supporting said pinion drive shaft;
a pair of laterally spaced differential support members for rotatably supporting said differential case, said differential support members spaced substantially along said output axis;
at least two second arm members each interconnecting said at least one pinion support member with one of said pair of differential support members to thereby define a cage-type space frame of said differential carrier; and
a mounting member attached to said differential carrier frame member for mounting said differential carrier to a vehicle sprung mass.

28. The differential carrier as defined in claim 27, wherein said mounting member is formed integrally with said differential carrier frame member.

29. The differential carrier as defined in claim 28, wherein said mounting member is formed integrally with said differential carrier frame member as a unitary single-piece component.

30. A cage-type differential carrier frame member for rotatably supporting a differential case of a differential assembly and a pinion drive shaft of a final drive assembly, said differential case rotatable about an output axis, said pinion drive shaft rotatable about an input axis, said differential carrier frame member comprising:
at least one pinion support member for rotatably supporting said pinion drive shaft;
a pair of laterally spaced differential support members for rotatably supporting said differential case, said differential support members spaced substantially along said output axis;
at least two second arm members each interconnecting said at least one pinion support member with one of said pair of differential support members to thereby define a cage-type space frame of said differential carrier; and
a flange member defining a rear access opening in said differential carrier and provided for securing thereto a rear cover plate.

31. The cage-type differential carrier frame member as defined in claim 30, wherein said flange member is attached to said differential support members.

32. The cage-type differential carrier frame member as defined in claim 30, wherein said flange member is formed integrally with said differential carrier frame member.

33. The cage-type differential carrier frame member as defined in claim 32, wherein said flange member is formed integrally with said differential carrier frame member as a unitary single-piece component.

34. A cage-type differential carrier frame member for rotatably supporting a differential case of a differential assembly and a pinion drive shaft of a final drive assembly, said differential case rotatable about an output axis, said pinion drive shaft rotatable about an input axis, said differential carrier frame member comprising:
at least one pinion support member for rotatably supporting said pinion drive shaft;
a pair of laterally spaced differential support members for rotatably supporting said differential case, said differential support members spaced substantially along said output axis;
at least two second arm members each interconnecting said at least one pinion support member with one of said pair of differential support members to thereby define a cage-type space frame of said differential carrier; and
a mounting member attached to said differential carrier frame member for mounting said differential carrier to a vehicle sprung mass.

35. The cage-type differential carrier frame member as defined in claim 34, wherein said mounting member is formed integrally with said differential carrier frame member.

36. The cage-type differential carrier frame member as defined in claim 35, wherein said mounting member is formed integrally with said differential carrier frame member as a unitary single-piece component.
